(19) United States
(12) Patent Application Publication
(10) Pub. No.: US 2019/0031892 A1
(43) Pub. Date: Jan. 31, 2019

(54) HALOGEN-FREE INTUMESCENT FIRE-PROOF COATING, AND USE THEREOF

(71) Applicant: CLARIANT PLASTICS & COATINGS LTD, Muttenz (CH)

(72) Inventors: Klaus BENDER, Vettweiss (DE); Andrea ZURSTRASSEN, Erftstadt (DE); Martin SICKEN, Köln (DE)

(73) Assignee: CLARIANT PLASTICS & COATINGS LTD, Muttenz (CH)

(21) Appl. No.: 16/082,572

(22) PCT Filed: Mar. 2, 2017
(86) PCT No.: PCT/EP2017/054842

§ 371 Date: Sep. 6, 2018

(30) Foreign Application Priority Data
Mar. 10, 2016 (DE) 10 2016 203 911.3

(51) Int. Cl. C09D 5/18; C09D 7/61; C09D 165/00

(52) U.S. Cl. CPC C09D 5/185; C09D 165/00; C09D 7/61

(57) ABSTRACT

The invention relates to a halogen-free, intumescent fire-proof coating, characterized in that it contains at least one terpene- and/or polyterpene-based film-forming binder, and to the use thereof.

Insulation layer-forming fire protection coatings, also known as intumescence coatings, have the feature that in the event of fire and under the corresponding action of heat they undergo foaming and this foaming of the abovementioned fire protection coating prevents or at least temporarily impedes passage of heat onto ceilings, steel constructions, walls, cables, pipes and other materials.

U.S. Pat. No. 49,652,961 describes a flame-retardant material composed of a flame-retardant coating material and an electrically conductive material. The flame-retardant coating material here is made of foam- and carbon-forming substances, a gas-generating compound, a film-forming binder, appropriate solvents and optionally further ingredients.

U.S. Pat. No. 4,879,320 claims a flame-retardant composition which is similar to that described in U.S. Pat. No. 49,652,961 but has a ceramic fiber material added to it instead of a conductive material.

U.S. Pat. No. 5,225,464 describes an aqueous intumescence formulation based on a reaction product of phosphoric acid, melamine and monoammonium phosphate which together with pentaerythritol, chlorinated hydrocarbons and further compounds, in particular polyvinyl acetate, is said to provide an improved intumescence coating material.

Numerous intumescent formulations are known from “Fire Retardants Formulations Handbook” (Author: Vijay Mohan Bhatnagar, 1972).

Finally, DE-A-4343668 describes expandable flame-retardant coating compositions comprising at least

4% to 25% by weight of a film-forming binder,
10% to 40% by weight of ammonium polyphosphate,
8% to 40% by weight of a substance which forms carbon under the action of heat,
6% to 25% by weight of a blowing agent,
0% to 5% by weight of a dispersing additive,
0% to 25% by weight of fillers.

The disadvantage of the abovementioned solvent-containing fire protection coatings of the prior art is altogether that they are halogen-containing and as binders use various esters based on mineral oil derivatives and that the coatings exhibit poor weather resistance on account of their inherent porosity.

The present invention accordingly has for its object to provide fire protection coatings which contain a film-forming binder based on natural materials and which do not rely on the use of halogen-containing components such as chloroparaffin for instance.

Fire protection coatings are highly filled formulations of reactive constituents having a pigment-volume concentration (PVC)—the volume ratio between pigments/fillers and the binder in the cured coating—in the supercritical region (CPVC).

Below the CPVC in the subcritical formulations the surfaces are completely covered. Only interfaces between pigment/filler and binder exist.

When the pigment proportion in the formulation is increased further, the CPVC is exceeded. In these supercritical formulations the surfaces are not completely covered. In addition to the interface between pigment/filler and binder there are now further interfaces between pigment/filler and air with the disadvantage that at the interface between pigment and air the pigment is no longer protected by the binder and the additives which may be present therein. This markedly impairs the weather resistance of the coating.

This is accelerated by possible penetration of water into the pores.

It is now been found that, surprisingly, the inventive fire protection coatings comprising binders based on terpenes and/or polyterpenes have a positive effect on weathering resistance even when the CPVC range is reached.

Furthermore, the use of chloroparaffin as plasticizer and blowing agent may be omitted without this having negative effects on fire protection properties.

The invention accordingly relates to a halogen-free, insulation layer-forming fire protection coating, which contains at least one film-forming binder based on terpenes and/or polyterpenes.

The terpenes are preferably terpenes as such or mixtures of terpenes with other substances, such as terpene-phenol resins, terpene-hydrocarbon resins, vinylaromatic terpene resins, colophony resins and esters thereof.

The polyterpenes are preferably synthetic and/or natural polyterpenes, polyterpene resins, rosin ester resins, fully or partially hydrogenated rosin ester resins, maleated derivatives of rosin ester resins, disproportionated derivatives, abietic esters and/or modified natural resins.

The film-forming binder preferably further contains at least a hydrocarbon resin, a vinylaromatically modified hydrocarbon resin, modified terpene resins, terpene co- or terpolymers, styrene-terpenes, α-methylstyrene terpenes, phenol-modified terpene resins and hydrogenated derivatives thereof, styrene resins, phenol-modified α-methylstyrene resins, acrylic acid copolymers, styrene-acrylic acid copolymers and aromatic, aliphatic or cycloaliphatic hydrocarbon resins of the C₅, C₉, C₉/C₁₀ type and modified or hydrogenated derivatives thereof.

The polyterpenes preferably derive from α-pinene, β-pinene, limonene, dipentene, α-phellandrene, β-phellandrene, δ-3-carene and/or δ-2-carene, α-terpinene, β-terpinene, gamma-terpinene, sylvestrene, α-terpinolene, psilimonene, isolimonene, 1-menthene, cis-2-menthene, trans-2-menthene, 3-menthene, 4(8)-p-menthene or mixtures thereof, from unsaturated cyclic and/or unsaturated linear terpenes.

It is preferable when the unsaturated cyclic terpenes are camphene, tricyclene, cadinene, caryophyllene and/or bornylene and the saturated linear terpenes are alloocimene, citronellene, pseudocitronellene, ocimene and/or mycrene.

It is preferable when the polyterpene resins contain at least one radical from the group of α-pinene, β-pinene, limonene, dipentene, α-phellandrene, β-phellandrene, δ-3-carene, δ-2-carene, α-terpinene, β-terpinene, gamma-terpinene, sylvestrene, α-terpinolene, psilimonene, isolimonene, 1-menthene, cis-2-menthene, trans-2-menthene, 3-menthene, 4(8)-p-menthene, camphene, tricyclene, cadinene, caryophyllene, bornylene, alloocimene, citronellene, pseudocitronellene, ocimene and/or mycrene.

It is preferable when the polyterpene resins further contain at least one monomeric radical from the group of isobutylene, 1-alkene, 2-alkene, trisubstituted alkene, vinylcyclohexene, piperylene, isoprene, 2-methyl-2-butene, 2-methyl-1-butene, cyclopentene, acyclic pentene, cyclopentadiene and/or dicyclopentadiene.

The terpene-phenol resins preferably contain at least one monomeric radical from the group of α-pinene, β-pinene, δ-3-carene and/or limonene and at least one monomeric radical from the group of styrene, indene, α-methylstyrene, aromatic alkylstyrene, divinylbenzene, divinylbenzene having one or more alkyl groups, isobutylene, diisobutylene, 1-alkene, 2-alkene, trisubstituted alkene, vinylcyclohexene, piperylene, isoprene, 2-methyl-2-butene, 2-methyl-1-butene, cyclopentene, acyclic pentene, cyclopentadiene and/or dicyclopentadiene and the phenol is phenol itself, mono-, di- and/or trisubstituted phenol and/or a hydroxyl-substituted naphthalene compound.

It is preferable when the terpene-hydrocarbon resins are α-pinene.

It is preferable when the vinylaromatically modified hydrocarbon resins are phenylethene (cinnamol).

It is preferable when the fire protection coating according to the invention contains film-forming binders, blowing agents, substances which are foam layer-forming and carbon-forming in the event of fire and also assistant and additive substances.

It is preferable when the film-forming binder further contains an organic polymer resin wherein said resin is selected from copolymers based on styrene and acrylic esters, from copolymers based on acrylic esters, from vinyltoluene/acrylate copolymers, from styrene/acrylate polymers, from homopolymers based on vinyl acetate, from copolymers based on vinyl acetate, ethylene and vinyl chloride, from copolymers based on vinyl acetate and the vinyl ester of a long-chain, branched carboxylic acid, from copolymers based on vinyl acetate and di-n-butyl maleate esters and/or acrylic esters, from vinyl/acrylate copolymers, from self-crosslinking polyurethane dispersions and/or mixtures thereof.

It is preferable when the fire protection coating according to the invention contains melamine, guanidine, salts thereof, melamine condensation products and/or dicyanodiamide as blowing agents.

The blowing agents are preferably melamine phoshate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate, melamine polyphosphates, melam polyphosphates, melem polyphosphates, melon polyphosphates, melamine cyanurate, melamine borate, melamine silicate, melam, melem, melon, guanidine phosphate, oligomeric esters of tris(hydroxyethyl) isocyanurate with aromatic polycarboxylic acids, benzoguanamine, tris(hydroxyethyl) isocyanurate, allantoin, glycouril, and/or urea cyanurate.

It is preferable when the fire protection coating according to the invention contains ammonium salts of phosphoric acids and/or polyphosphoric acids as foam-forming substances.

The abovementioned ammonium salts are preferably nitrogen-containing phosphates (ammonium polyphosphates) of formulae (NH₄)_{y}H_{3-y}PO₄ bzw. (NH₄PO₃)_{z} where y is 1 to 3 and z is 1 to 10 000.

The ammonium polyphosphate preferably has a crystal form of phase I, II, III, IV, V or VI or mixtures thereof.

It is preferable when the ammonium polyphosphate is microencapsulated with organofunctional silanes, melamine-formaldehyde resins and emulsions based on (meth)acrylate resins, on styrene/acrylate copolymers, urethanes, on ethylene/vinyl acetate copolymers, on rubber or mixtures thereof.

It is preferable when the fire protection coating according to the invention contains carbohydrates as carbon-forming substances.

Preferably employed as carbohydrates are pentaerythritol, dipentaerythritol, tripentaerythritol and/or polycondensates of pentaerythritol.

Preferably employed as assistant and additive substances are glass fibers, mineral fibers, kaolin, talc, aluminum oxide, aluminum hydroxide, magnesium hydroxide, precipitated silicas, silicates and/or pulverized celluloses.

It is preferable when the fire protection coating according to the invention contains

5% to 69.7% by weight of film-forming binder,
5% to 25% by weight of blowing agent,
5% to 40% by weight of foam-forming substance,
5% to 25% by weight of carbon-forming substance,
5% to 40% by weight of assistant and additive substances,
0.2% to 10% by weight of thickener,
0.1% to 10% by weight of dispersing additives and
10% to 40% by weight of solvent and/or solvent mixtures, wherein the components sum to 100% by weight.

It is particularly preferable when the fire protection coating according to the invention contains

8% to 51.4% by weight of film-forming binder,
6% to 20% by weight of blowing agent,
15% to 35% by weight of foam-forming substance,
6% to 20% by weight of carbon-forming substance,
5% to 20% by weight of assistant and additive substances,
0.5% to 8% by weight of thickener,
0.1% to 8% by weight of dispersing additives and
14% to 40% by weight of solvent and/or solvent mixtures, wherein the components sum to 100% by weight.

It is especially preferable when the fire protection coating according to the invention contains

10% to 36.1% by weight of film-forming binder,
7% to 12% by weight of blowing agent,
20% to 30% by weight of foam-forming substance,
8% to 10% by weight of carbon-forming substance,
7% to 10% by weight of assistant and additive substances,
1% to 5% by weight of thickener,
0.8% to 3% by weight of dispersing additives and
21% to 35% by weight of solvent and/or solvent mixtures, wherein the components sum to 100% by weight.

The invention also relates to the use of the fire protection coating according to the invention for coating steel constructions such as steel beams and supports, ceilings, walls, cables, pipes, conduits, cable and combination bulkheads, doors, curtains, smoke barriers, blinds, safety cabinets, installation cabinets and the like.

The invention relates in particular to the use of the fire protection coating according to the invention on steel, wood, wood-based materials, paper, mineral wool, plasterboard, plastics, metals, alloys, fabrics made of synthetic or natural fibers and other suitable materials and/or as solder mask and for electrical switches and circuits.

The fire protection coating according to the invention is very good for constructive fire protection of hollow profiles and H-profiles and also in workshop applications and in areas in which an elevated weathering resistance is required.

Polyterpenes are natural isoprenoid compounds occurring for example in citrus fruits or tree resins and constructed from C₅-building blocks (active isoprene).

Hemiterpenes (C₅) to tetraterpenes (C₄₀) are distinguished. Higher molecular weight polymeric units >C₄₀ are referred to as polyterpenes and occur inter alia in natural rubber and guttapercha.

Examples of polyterpenes:

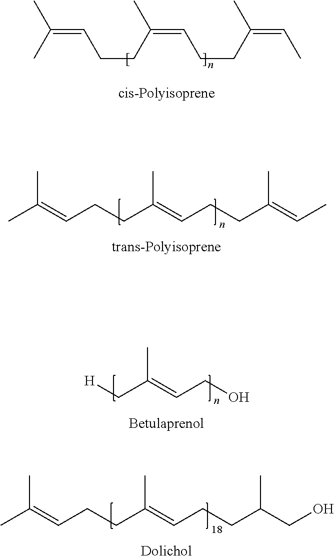

By polymerization with other suitable monomers tailored polyterpene resins may be produced for the particular industrial application.

The film-forming binder employed in the fire protection coating according to the invention may derive from the group of polyterpene resin, terpene-phenol-resin, terpene-hydrocarbon resin, vinylaromatic terpene resin, hydrocarbon resin and/or vinylaromatic-modified hydrocarbon resin.

It is preferable to employ polyterpene resins.

Particularly preferred here are polyterpene resins having a softening point of 10° C. to 150° C. and very particularly preferred here are polyterpene resins having a softening point of 110° C. to 130° C.

The polyterpene resin may comprise at least one monomeric radical selected from the group of α-pinene, β-pinene, limonene, dipentene, β-phellandrene, δ-3-carene and δ-2-carene.

It is preferable to employ resins made of α-pinene, β-pinene and/or limonene. It is particularly preferable to employ polyterpene resins made of α-pinene.

Preferred raw materials for polyterpene resins employable according to the invention are α- and β-pinene which are obtained for instance from the essential oils of myrtle, spruce needles, dill, fennel, coriander and caraway.

δ-Pinene is preferably obtained from rosemary.

The most important natural source of monoterpenoid raw materials is pine resin.

Turpentine oil comprises about 60% α-pinene.

(+)-α-Pinene is isolated for example from Greek turpentine oil and (−)-α-pinene from Spanish turpentine oil.

It is preferable when the insulation layer-forming fire protection coating according to the invention is halogen-free.

The fire protection coating (intumescence coating) according to the invention is employed in the form of a brushable, sprayable or rollable coating composition for protection of a very wide variety of substrates.

The abovementioned amounts of film-forming binder, blowing agent, foam-forming substance, carbon-forming substance, assistant and additive substances, thickener, dispersing additives and solvent and/or solvent mixtures may be employed as formulations in the inventive production process for a composition as an insulation layer-forming fire protection coating.

In the practiced production process a polyterpene resin as a binder may be mixed with an agent which is foam-forming in the event of fire and optional further assistant and additive substances in a high-shear dissolver.

For rapid and reliable dispersing of the solids small particle sizes are preferred.

Preferred median particle sizes d₅₀ for

ammonium polyphosphate are 0.02-1000 μm,
carbon-forming substance are 0.02-900 μm,
blowing agent are 0.02-900 μm,
dispersing additive are 0.02-900 μm,
fillers and pigments are 0.02-900 μm.

Particularly preferred median particle sizes d₅₀ for

ammonium polyphosphate are 0.1-30 μm,
carbon-forming substance are 0.1-50 μm,
blowing agent are 0.1-50 μm,
dispersing additive are 0.1-80 μm,
fillers and pigments are 0.1-125 μm.

The invention is elucidated without limitation in the examples which follow.

The following products were employed in the examples:

Pliolite® AC 80 (Omnova-Solutions/France)

This is a Newtonian thermoplastic resin based on styrene-acrylate copolymers.

Piccolyte® A125 (Pinova, Inc., Brunswick, Ga., USA)

This is an inert, thermoplastic polyterpene resin based on alpha-pinene having an Mₙ (number average of molecular weight) of 725, a melting point of 122-128° C. and a flashpoint >175° C.

Piccolyte® C125 (Pinova, Inc., Brunswick, Ga., USA)

This is an inert, thermoplastic polyterpene resin based on delta-limonene having an Mₙ of 650, a melting point of 122-128° C. and a flashpoint of 241° C.

Piccolyte® S125 (Pinova, Inc., Brunswick, Ga., USA)

This is an inert, thermoplastic hydrocarbon resin based on beta-pinene having an Mₙ of 690, a melting point of 122-128° C. and a flashpoint >175° C.

Sylvares® TR 90 (Arizona Chemicals, USA)

This is a polyterpene resin based on alpha-pinene having an Mₙ of 580, a melting point of 90° C. and a glass transition temperature (TG) of 40° C.

Sylvares® TR 105 (Arizona Chemicals, USA)

This is a polyterpene resin based on beta-pinene having an Mₙ of 620, a melting point of 105° C. and a TG of 55° C.

Sylvares® TR B115 (Arizona Chemicals, USA)

This is a polyterpene resin based on alpha-pinene having an Mₙ of 1150, a melting point of 115° C. and a TG of 70° C.

Sylvares® TR 7115 (Arizona Chemicals, USA)

This is a polyterpene resin based on alpha-pinene having an Mₙ of 650, a melting point of 105° C. and a TG of 70° C.

Exolit® AP 422 (Clariant Produkte (Deutschland) GmbH, Frankfurt am Main)

This is a free-flowing, pulverulent, poorly-soluble-in-water ammonium polyphosphate of formula (NH₄PO₃)ₙ where n=20 to 1000, in particular 500 to 1000. The proportion of particles having a particle size smaller than 45 μm is more than 99%.

Exolit® AP 462 (Clariant Produkte (Deutschland) GmbH, Frankfurt am Main) Microencapsulated ammonium polyphosphate based on Exolit® AP 422 which contains approximately 1.0% by mass of encapsulating material composed of a cured melamine/formaldehyde resin.

Disperbyk®-2163 (BYK, Wesel)

Dispersing additive

(Luvotix® PA 20 XA (Lehmann & Voss & Co., Hamburg)

Thixotroping agent

The intumescence formulations—then later applied as fire protection coatings—were produced as follows:
a) the solvent/the solvent mixture is initially charged at room temperature and the respective resin is dissolved therein with stirring before coatings additives such as dispersing additives and optionally defoamers are added with stirring,
b) foam-forming substance, blowing agent and carbon-forming substance as well as assistant and additive substances (for example titanium dioxide, fibers and fillers) are sprinkled in with stirring at low rpm,
c) thixotroping agent is sprinkled in with stirring,
d) dispersed for at least 25 minutes with high shear forces while maintaining a temperature of 50° C. to 60° C.,
e) homogeneously dispersed for at least 5 minutes and desired viscosity adjusted by addition of solvent or solvent mixtures.

### EXAMPLE 1 (COMPARATIVE)

27 parts by weight of Exolit® AP 422

10 parts by weight of Pliolite® AC 80

6 parts by weight of chloroparaffin

8 parts by weight of melamine

8 parts by weight of pentaerythritol

ad 100 parts by weight of assistant and additive substances, thickeners, dispersing additives and solvents according to table 1.

### EXAMPLE 2

27 parts by weight of Exolit® AP 422

16 parts by weight of Piccolyte® A125

8 parts by weight of melamine

8 parts by weight of pentaerythritol

ad 100 parts by weight of assistant and additive substances, thickeners, dispersing additives and solvents according to table 1.

### EXAMPLE 3

27 parts by weight of Exolit® AP 422

12 parts by weight of Piccolyte® A125

8 parts by weight of melamine

8 parts by weight of pentaerythritol

ad 100 parts by weight of assistant and additive substances, thickeners, dispersing additives and solvents according to table 1.

### EXAMPLE 4

27 parts by weight of Exolit® AP 422

20 parts by weight of Piccolyte® A125

8 parts by weight of melamine

8 parts by weight of pentaerythritol

ad 100 parts by weight of assistant and additive substances, thickeners, dispersing additives and solvents according to table 1.

### EXAMPLE 5

27 parts by weight of Exolit® AP 422

10 parts by weight of Piccolyte® A125

6 parts by weight of Piccolyte® C125

8 parts by weight of melamine

8 parts by weight of pentaerythritol

ad 100 parts by weight of assistant and additive substances, thickeners, dispersing additives and solvents according to table 1.

### EXAMPLE 6

27 parts by weight of Exolit® AP 422

10 parts by weight of Piccolyte® A125

6 parts by weight of Piccolyte® S125

8 parts by weight of melamine

8 parts by weight of pentaerythritol

ad 100 parts by weight of assistant and additive substances, thickeners, dispersing additives and solvents according to table 1.

### EXAMPLE 7

27 parts by weight of Exolit® AP 422

10 parts by weight of Piccolyte® A125

6 parts by weight of Pliolite® AC 80

8 parts by weight of melamine

8 parts by weight of pentaerythritol

ad 100 parts by weight of assistant and additive substances, thickeners, dispersing additives and solvents according to table 1.

TABLE 1

| | Amounts and type | | | | | | | Solvent mixture of |
|---|---|---|---|---|---|---|---|---|
| | of film-forming | Blowing | Foam- | | | | | 75 pbw xylene |
| | binder (terpene/ | agent | forming | Carbon-forming | Assistant | | | 20 pbw Shellsol |
| | polyterpene) | (melamine/ | substance | substance | and additive | | Dispersing | 100/140 |
| | (chloroparaffin) | MPP) | (APP) | (carbohydrates) | substances | Thickeners | additives | 5 pbw methyl ethyl |
| Example | parts by weight | | | | | | | ketone |
| 1 (C) | 10 Pliolite AC80 | 8 melamine | 27 AP422 | 8 pentaerythritol | 8 titanium | 0.8 Luvotix ® | 0.2 Disperbyk ® | 32 |
| | 6 chloroparaffin | | | | dioxide | PA 20 XA | 2163 | |
| 2 | 16 Piccolyte A125 | 8 melamine | 27 AP422 | 8 pentaerythritol | 8 titanium | 0.8 Luvotix ® | 0.2 Disperbyk ® | 32 |
| | | | | | dioxide | PA 20 XA | 2163 | |
| 3 | 12 Piccolyte A125 | 8 melamine | 27 AP422 | 8 pentaerythritol | 8 titanium | 0.8 Luvotix ® | 0.2 Disperbyk ® | 36 |
| | | | | | dioxide | PA 20 XA | 2163 | |
| 4 | 20 Piccolyte A125 | 8 melamine | 27 AP422 | 8 pentaerythritol | 8 titanium | 0.8 Luvotix ® | 0.2 Disperbyk ® | 28 |
| | | | | | dioxide | PA 20 XA | 2163 | |
| 5 | 10 Piccolyte A125 | 8 melamine | 27 AP422 | 8 pentaerythritol | 8 titanium | 0.8 Luvotix ® | 0.2 Disperbyk ® | 32 |
| | 6 Piccolyte C 125 | | | | dioxide | PA 20 XA | 2163 | |
| 6 | 10 Piccolyte A125 | 8 melamine | 27 AP422 | 8 pentaerythritol | 8 titanium | 0.8 Luvotix ® | 0.2 Disperbyk ® | 32 |
| | 6 Piccolyte S 125 | | | | dioxide | PA 20 XA | 2163 | |
| 7 | 10 Piccolyte A125 | 8 melamine | 27 AP422 | 8 pentaerythritol | 8 titanium | 0.8 Luvotix ® | 0.2 Disperbyk ® | 32 |
| | 6 Pliolite AC80 | | | | dioxide | PA 20 XA | 2163 | |

(C) = comparison
pbw = parts by weight

### EXAMPLE 8

22 parts by weight of Exolit® AP 422

20 parts by weight of Piccolyte® A125

10 parts by weight of melamine

8 parts by weight of pentaerythritol

ad 100 parts by weight of assistant and additive substances, thickeners, dispersing additives and solvents according to table 2.

### EXAMPLE 9

20 parts by weight of Exolit® AP 422

10 parts by weight of Sylvares TR 90

12 parts by weight of melamine

10 parts by weight of pentaerythritol

ad 100 parts by weight of assistant and additive substances, thickeners, dispersing additives and solvents according to table 2.

### EXAMPLE 10

30 parts by weight of Exolit® AP 422

25 parts by weight of Sylvares TR 90

10 parts by weight of melamine

10 parts by weight of pentaerythritol

ad 100 parts by weight of assistant and additive substances, thickeners, dispersing additives and solvents according to table 2.

### EXAMPLE 11

25 parts by weight of Exolit® AP 422

12 parts by weight of Sylvares TR 105

8 parts by weight of melamine

8 parts by weight of pentaerythritol

ad 100 parts by weight of assistant and additive substances, thickeners, dispersing additives and solvents according to table 2.

### EXAMPLE 12

25 parts by weight of Exolit® AP 422

14 parts by weight of Sylvares TR 105

8 parts by weight of melamine

10 parts by weight of pentaerythritol

ad 100 parts by weight of assistant and additive substances, thickeners, dispersing additives and solvents according to table 2.

### EXAMPLE 13

25 parts by weight of Exolit® AP 422

16 parts by weight of Sylvares TR B 115

10 parts by weight of melamine

8 parts by weight of pentaerythritol

ad 100 parts by weight of assistant and additive substances, thickeners, dispersing additives and solvents according to table 2.

### EXAMPLE 14

28 parts by weight of Exolit® AP 422

10 parts by weight of Sylvares TR 1100

7 parts by weight of melamine

8 parts by weight of pentaerythritol

ad 100 parts by weight of assistant and additive substances, thickeners, dispersing additives and solvents according to table 2.

### EXAMPLE 15

24 parts by weight of Exolit® AP 422

16 parts by weight of Sylvares TR 7115

10 parts by weight of melamine

10 parts by weight of pentaerythritol

ad 100 parts by weight of assistant and additive substances, thickeners, dispersing additives and solvents according to table 2.

TABLE 2

| | Amounts and type | | | | | | | Solvent mixture of |
|---|---|---|---|---|---|---|---|---|
| | of film-forming | Blowing | Foam- | | | | | 75 pbw xylene |
| | binder (terpene/ | agent | forming | Carbon-forming | Assistant | | | 20 pbw Shellsol |
| | polyterpene) | (melamine/ | substance | substance | and additive | | Dispersing | 100/140 |
| | (chloroparaffin) | MPP) | (APP) | (carbohydrates) | substances | Thickeners | additives | 5 pbw methyl ethyl |
| Example | parts by weight | | | | | | | ketone |
| 8 | 20 Piccolyte A125 | 10 melamine | 22 AP422 | 8 pentaerythritol | 8 titanium | 0.8 Luvotix ® | 0.2 Disperbyk ® | 31 |
| | | | | | dioxide | PA 20 XA | 2163 | |
| 9 | 10 Sylvares TR 90 | 12 melamine | 30 AP422 | 10 pentaerythritol | 10 titanium | 0.8 Luvotix ® | 0.2 Disperbyk ® | 27 |
| | | | | | dioxide | PA 20 XA | 2163 | |
| 10 | 25 Sylvares TR 90 | 10 melamine | 20 AP422 | 10 pentaerythritol | 8 titanium | 0.8 Luvotix ® | 0.2 Disperbyk ® | 26 |
| | | | | | dioxide | PA 20 XA | 2163 | |
| 11 | 12 Sylvares TR 90 | 8 melamine | 25 AP422 | 8 pentaerythritol | 8 titanium | 0.8 Luvotix ® | 0.2 Disperbyk ® | 38 |
| | | | | | dioxide | PA 20 XA | 2163 | |
| 12 | 14 Sylvares TR 90 | 8 melamine | 25 AP422 | 10 pentaerythritol | 9 titanium | 0.8 Luvotix ® | 0.2 Disperbyk ® | 32 |
| | | | | | dioxide | PA 20 XA | 2163 | |
| 13 | 16 Sylvares TR 90 | 10 melamine | 25 AP422 | 8 pentaerythritol | 10 titanium | 0.8 Luvotix ® | 0.2 Disperbyk ® | 30 |
| | | | | | dioxide | PA 20 XA | 2163 | |
| 14 | 10 Sylvares TR 90 | 7 melamine | 28 AP422 | 8 pentaerythritol | 8 titanium | 0.8 Luvotix ® | 0.2 Disperbyk ® | 38 |
| | | | | | dioxide | PA 20 XA | 2163 | |
| 15 | 16 Sylvares TR 90 | 10 melamine | 24 AP422 | 10 pentaerythritol | 7 titanium | 0.8 Luvotix ® | 0.2 Disperbyk ® | 32 |
| | | | | | dioxide | PA 20 XA | 2163 | |

pbw = parts by weight

The thus produced intumescence formulation was applied as an intumescence coating to a radiated steel sheet SA 2.5 (280×280×5 mm) and a fire test according to DIN 4102 part 8, fire curve ISO 834 (ETK) with a dry film thickness of 1000 μm was performed. This resulted in the fire resistance times shown in table 3 (T_{critical}=500° C.).

The inventive intumescence formulations using polyterpene resins are therefore exceptional for producing effective intumescence coatings.

TABLE 3

| | Film-forming binder | | | |
|---|---|---|---|---|
| Intumescence | Pliolite AC | | | T_{critical} = |
| formulations | 80 | Piccolyte A 125 // | Expansion | 500° C. |
| from | [% by wt.] | C 125/S 125 | x-fold | [min.] |
| Example 1 | 10 | 0/0/0 | 35 | 55 |
| Example 2 | 0 | 16/0/0 | 60 | 76 |
| Example 3 | 0 | 12/0/0 | 45 | 62 |
| Example 4 | 0 | 20/0/0 | 80 | 43 |
| Example 5 | 0 | 10/6/0 | 65 | 70 |
| Example 6 | 0 | 10/0/6 | 80 | 83 |
| Example 7 | 6 | 10/0/0 | 40 | 47 |

To test water resistance the thus obtained fire protection coating is applied to an aluminum sheet (70×150×0.8 mm) (film thickness before drying is 1 mm) and subsequently dried at 26° C. for 24 h. Half of the sheet is then immersed longitudinally in a water bath for a further 24 h and blister formation at the surface is then visually determined. Evaluation was carried out in photographic/computer-assisted fasion.

Table 4 reports the proportion of the surface immersed in water affected by blistering in %. The greater the affected surface area the lower the water resistance. This is important for exterior applications in particular. When the coating is generally exposed to moisture and weather a good and lasting surface stability is of essential importance to ensure the smoothness of the applied coating and the longevity thereof.

TABLE 4

| | Film-forming binder | | |
|---|---|---|---|
| Intumescence | Pliolite AC | | |
| formulations | 80 | Piccolyte A 125 // | Affected |
| from | [% by wt.] | C 125/S 125 | surface area in % |
| Example 1 | 10 | 0/0/0 | 35 |
| Example 2 | 0 | 16/0/0 | 52 |
| Example 3 | 0 | 12/0/0 | 68 |
| Example 4 | 0 | 20/0/0 | 42 |
| Example 5 | 0 | 10/6/0 | 50 |
| Example 6 | 0 | 10/0/6 | 38 |
| Example 7 | 6 | 10/0/0 | 76 |

When in any of examples 1 to 16 the foam-forming substance Exolit® AP 422 is exchanged for Exolit® AP 462 given an otherwise identical overall composition, analogous results are obtained for the fire resistance times and in the testing for blister formation.

The following examples 16 to 20 describe the effect on drying time of changing the solvent system.

### EXAMPLE 16

27 parts by weight of Exolit® AP 422

16 parts by weight of Piccolyte® A125

8 parts by weight of melamine

8 parts by weight of pentaerythritol

8 parts by weight of titanium dioxide

30 parts by weight of mixture of xylene and Shellsol® 100/140 (Table 3)

ad 100 parts by weight of thickener (Luvotix® PA 20 XA), assistant and additive substances (fibers and fillers), dispersing additives, solvent (methyl ethyl ketone (MEK)).

### EXAMPLE 17

27 parts by weight of Exolit® AP 422

16 parts by weight of Piccolyte® A125

8 parts by weight of melamine

8 parts by weight of pentaerythritol

8 parts by weight of titanium dioxide

30 parts by weight of mixture of xylene, Shellsol® 100/140 and 2-propanol (table 3)

ad 100 parts by weight of thickener (Plioway® EC-T), assistant and additive substances (fibers and fillers), dispersing additives, solvent (methyl ethyl ketone (MEK)).

### EXAMPLE 18

27 parts by weight of Exolit® AP 422

16 parts by weight of Piccolyte® A125

8 parts by weight of melamine

8 parts by weight of pentaerythritol

8 parts by weight of titanium dioxide

30 parts by weight of mixture of xylene, Shellsol® 100/140 and 2-propanol (table 3)

ad 100 parts by weight of thickener (Luvotix® PA 20 XA), assistant and additive substances (fibers and fillers), dispersing additives, solvent (methyl ethyl ketone (MEK)).

### EXAMPLE 19

27 parts by weight of Exolit® AP 422

16 parts by weight of Piccolyte® A125

8 parts by weight of melamine

8 parts by weight of pentaerythritol

8 parts by weight of titanium dioxide

30 parts by weight of mixture of xylene, Shellsol® 100/140 and 2-propanol (table 3)

ad 100 parts by weight of thickener (Luvotix® PA 20 XA), assistant and additive substances (fibers and fillers), dispersing additives, solvent (methyl ethyl ketone (MEK)).

### EXAMPLE 20

27 parts by weight of Exolit® AP 422

16 parts by weight of Piccolyte® A125

8 parts by weight of melamine

8 parts by weight of pentaerythritol

8 parts by weight of titanium dioxide

30 parts by weight of mixture of xylene, Shellsol® 100/140 and 2-propanol (table 3)

ad 100 parts by weight of thickener (Luvotix® PA 20 XA), assistant and additive substances (fibers and fillers), dispersing additives, solvent (methyl ethyl ketone (MEK)).

The drying rate of the intumescence coating according to the invention may be greatly increased by partial replacement of the solvent xylene by 2-propanol. The drying time is defined as the time at which a constant weight over a period of 3 days is achieved and the nail test shows no marking in the coating surface.

Table 5 shows the effect of the 2-propanol content on the drying rate of a 2000 μm coating on a steel plate at room temperature. The drying time decreases continuously with increasing 2-propanol content.

TABLE 5

| | Solvent system | | | |
|---|---|---|---|---|
| Intumescence | xylene | Shellsol | | Drying time at RT |
| formulation | [% by | 100/140 | 2-propanol | DFT = 2000 μm |
| from | wt.] | [% by wt.] | [% by wt.] | [days] |
| Example 16 | 50 | 50 | 0 | 46 |
| Example 17 | 25 | 50 | 25 | 38 |
| Example 18 | 15 | 50 | 35 | 32 |
| Example 19 | 10 | 50 | 40 | 24 |
| Example 20 | 5.0 | 47.5 | 47.5 | 20 |

It is finally noted again that the preceding detailed compositions and coatings are merely preferred exemplary embodiments which may be modified by those skilled in the art in a very wide variety of ways without departing from the scope of the invention insofar as defined by the claims. In particular other concentrations of the respective components may be used provided the compound has a sufficient fire protection suitability.

The inventive intumescence compositions exhibited a reduction in the start temperature of the intumescence reaction to as low as 220° C. (demonstrated by thermogravimetric analyses (TGA)) so that in the event of fire the protective fire protection foam may be formed sooner, i.e. at relatively low fire temperatures, thus preventing damage more quickly.

1. A halogen-free, insulation layer-forming fire protection coating, comprising at least one film-forming binder based on terpenes, polyterpenes or mixtures thereof.

2. The fire protection coating as claimed in claim 1, wherein the terpenes are terpenes as such or mixtures of terpenes with other substances.

3. The fire protection coating as claimed in claim 1, wherein the polyterpenes are synthetic and/or natural polyterpenes, polyterpene resins, rosin ester resins, fully or partially hydrogenated rosin ester resins, maleated derivatives of rosin ester resins, disproportionated derivatives, abietic esters, modified natural resins or mixtures thereof.

4. The fire protection coating as claimed in claim 1, wherein the film-forming binder further comprises at least a hydrocarbon resin, a vinylaromatically modified hydrocarbon resin, modified terpene resins, terpene co- or terpolymers, styrene-terpenes, α-methylstyrene terpenes, phenol-modified terpene resins and hydrogenated derivatives thereof, styrene resins, phenol-modified α-methylstyrene resins, acrylic acid copolymers, styrene-acrylic acid copolymers and aromatic, aliphatic or cycloaliphatic hydrocarbon resins of the C₅, C₉, C₉/C₁₀ type and modified or hydrogenated derivatives thereof.

5. The fire protection coating as claimed in claim 1, wherein the polyterpenes derive from α-pinene, β-pinene, limonene, dipentene, α-phellandrene, β-phellandrene, δ-3-carene and/or δ-2-carene, α-terpinene, β-terpinene, gamma-terpinene, sylvestrene, α-terpinolene, psilimonene, isolimonene, 1-menthene, cis-2-menthene, trans-2-menthene, 3-menthene, 4(8)-p-menthene or mixtures thereof, from unsaturated cyclic, unsaturated linear terpenes or mixtures thereof.

6. The fire protection coating as claimed in claim 5, wherein the unsaturated cyclic terpenes are camphene, tricyclene, cadinene, caryophyllene, bornylene or mixtures thereof and the saturated linear terpenes are alloocimene, citronellene, pseudocitronellene, ocimene, mycrene or mixtures thereof.

7. The fire protection coating as claimed in claim 1, wherein the polyterpene resins contain at least one radical selected from the group consisting of α-pinene, β-pinene, limonene, dipentene, α-phellandrene, β-phellandrene, δ-3-carene, δ-2-carene, α-terpinene, β-terpinene, gamma-terpinene, sylvestrene, α-terpinolene, psilimonene, isolimonene, 1-menthene, cis-2-menthene, trans-2-menthene, 3-menthene, 4(8)-p-menthene, camphene, tricyclene, cadinene, caryophyllene, bornylene, alloocimene, citronellene, pseudocitronellene, ocimene, mycrene and mixtures thereof.

8. The fire protection coating as claimed in claim 1, wherein the polyterpene resins further comprise at least one monomeric radical selected from the group consisting of isobutylene, 1-alkene, 2-alkene, trisubstituted alkene, vinylcyclohexene, piperylene, isoprene, 2-methyl-2-butene, 2-methyl-1-butene, cyclopentene, acyclic pentene, cyclopentadiene, dicyclopentadiene and mixtures thereof.

9. The fire protection coating as claimed in claim 1, wherein the terpene-phenol resins comprise at least one monomeric radical selected from the group consisting of α-pinene, β-pinene, δ-3-carene, limonene and mixtures thereof and at least one monomeric radical selected from the group consisting of styrene, indene, α-methylstyrene, aromatic alkylstyrene, divinylbenzene, divinylbenzene having one or more alkyl groups, isobutylene, diisobutylene, 1-alkene, 2-alkene, trisubstituted alkene, vinylcyclohexene, piperylene, isoprene, 2-methyl-2-butene, 2-methyl-1-butene, cyclopentene, acyclic pentene, cyclopentadiene, dicyclopentadiene and mixtures thereof and the phenol is phenol itself, mono-, di- and/or trisubstituted phenol and/or a hydroxyl-substituted naphthalene compound.

10. The fire protection coating as claimed in claim 1, wherein the terpene-hydrocarbon resins are α-pinene, β-pinene, delta-limonene or mixtures thereof.

11. The fire protection coating as claimed in claim 1, wherein the vinylaromatically modified hydrocarbon resins are phenylethene (cinnamol).

12. The fire protection coating as claimed in claim 1, further comprising film-forming binders, blowing agents, substances which are foam layer-forming and carbon-forming in the event of fire and also assistant and additive substances, thickeners, dispersing additives and solvents.

13. The fire protection coating as claimed in claim 12, wherein the film-forming binder further comprises an organic polymer resin selected from the group consisting of copolymers based on styrene and acrylic esters, copolymers based on acrylic esters, vinyltoluene/acrylate copolymers, styrene/acrylate polymers, homopolymers based on vinyl acetate, copolymers based on vinyl acetate, ethylene and vinyl chloride, copolymers based on vinyl acetate and the vinyl ester of a long-chain, branched carboxylic acid, copolymers based on vinyl acetate and di-n-butyl maleate esters and/or acrylic esters, vinyl/acrylate copolymer, self-crosslinking polyurethane dispersions and mixtures thereof.

14. The fire protection coating as claimed in claim 1, further comprising a blowing agent selected from the group consisting of melamine, guanidine, salts thereof, melamine condensation products, dicyanodiamide and mixtures thereof.

15. The fire protection coating as claimed in claim 14, wherein the blowing agents are melamine phoshate, dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate, melamine polyphosphates, melam polyphosphates, melem polyphosphates, melon polyphosphates, melamine cyanurate, melamine borate, melamine silicate, melam, melem, melon, guanidine phosphate, oligomeric esters of tris(hydroxyethyl) isocyanurate with aromatic polycarboxylic acids, benzoguanamine, tris(hydroxyethyl) isocyanurate, allantoin, glycouril, urea cyanurate or mixtures thereof.

16. The fire protection coating as claimed in claim 1, further comprising a foam-forming substance selected from the group consisting of ammonium salts of phosphoric acids, polyphosphoric acids and mixtures thereof.

17. The fire protection coating as claimed in claim 16, further comprising nitrogen-containing phosphates (ammonium polyphosphates) of formulae (NH₄)_{y}H_{3-y}PO₄/(NH₄PO₃)_{z} where y is 1 to 3 and z is 1 to 10 000.

18. The fire protection coating as claimed in claim 16, wherein the ammonium polyphosphate has a crystal form of phase I, II, III, IV, V, VI or mixtures thereof.

19. The fire protection coating as claimed in claim 16, wherein the ammonium polyphosphate is microencapsulated with organofunctional silanes, melamine-formaldehyde resins and emulsions based on (meth)acrylate resins, on styrene/acrylate copolymers, urethanes, on ethylene/vinyl acetate copolymers, on rubber or mixtures thereof.

20. The fire protection coating as claimed in claim 1, further comprising carbohydrates as carbon-forming substances.

21. The fire protection coating as claimed in claim 20, wherein the carbohydrates are selected from the group consisting of pentaerythritol, dipentaerythritol, tripentaerythritol, polycondensates of pentaerythritol and mixtures thereof.

22. The fire protection coating as claimed in claim 1, further comprising assistant or additive substances selected from the group consisting of glass fibers, mineral fibers, kaolin, talc, aluminum oxide, aluminum hydroxide, magnesium hydroxide, precipitated silicas, silicates, pulverized celluloses and mixtures thereof.

23. The fire protection coating as claimed in claim 1, comprising
5% to 69.7% by weight of film-forming binder,
5% to 25% by weight of blowing agent,
5% to 40% by weight of foam-forming substance,
5% to 25% by weight of carbon-forming substance,
5% to 40% by weight of assistant and additive substances,
0.2% to 10% by weight of thickener,
0.1% to 10% by weight of dispersing additives and
10% to 40% by weight of solvent and/or solvent mixtures, wherein the components sum to 100% by weight.

24. The fire protection coating as claimed in claim 1, comprising
8% to 51.4% by weight of film-forming binder,
6% to 20% by weight of blowing agent,
15% to 35% by weight of foam-forming substance,
6% to 20% by weight of carbon-forming substance,
5% to 20% by weight of assistant and additive substances,
0.5% to 8% by weight of thickener,
0.1% to 8% by weight of dispersing additives and
14% to 40% by weight of solvent and/or solvent mixtures, wherein the components sum to 100% by weight.

25. The fire protection coating as claimed in claim 1, comprising
10% to 36.1% by weight of film-forming binder,
7% to 12% by weight of blowing agent,
20% to 30% by weight of foam-forming substance,
8% to 10% by weight of carbon-forming substance,
7% to 10% by weight of assistant and additive substances,
0.8% to 3% by weight of thickener,
0.1% to 5% by weight of dispersing additives and
21% to 35% by weight of solvent and/or solvent mixtures, wherein the components sum to 100% by weight.

26. A coated steel construction comprising a fire protection coating as claimed in claim 1.

27. Steel, wood, wood-based materials, paper, mineral wool, plasterboard, plastics, metals, alloys, fabrics made of synthetic or natural fibers and other suitable materials, a solder mask electrical switches and circuits comprising a fire protection coating as claimed in claim 1.
